(19) United States
(12) Patent Application Publication
(10) Pub. No.: US 2026/0091514 A1
(43) Pub. Date: Apr. 2, 2026

(54) SENSOR MODULE, ROBOT HAND, AND ROBOT SYSTEM

(71) Applicants: JAPAN AVIATION ELECTRONICS INDUSTRY, LIMITED, Tokyo (JP); The University of Electro-Communications, Tokyo (JP)

(72) Inventors: Junya SATO, Tokyo (JP); Takuya DAIGO, Tokyo (JP); Akihiro TOMIOKA, Tokyo (JP); Shunsuke KUDOH, Tokyo (JP); Kohei KIMURA, Tokyo (JP); Takayuki KOGA, Tokyo (JP)

(73) Assignees: JAPAN AVIATION ELECTRONICS INDUSTRY, LIMITED, Tokyo (JP); The University of Electro-Communications, Tokyo (JP)

(21) Appl. No.: 19/196,990

(22) Filed: May 2, 2025

(30) Foreign Application Priority Data
Jun. 5, 2024 (JP) 2024-091366

(51) Int. Cl. B25J 15/08; B25J 13/08

(52) U.S. Cl. CPC B25J 15/08; B25J 13/085

(57) ABSTRACT

A sensor module of the present invention is arranged on a finger of a robot hand. The finger has a pulp region for applying a force to a subject, and a back region opposite to the pulp region. The sensor module of the present invention includes two or more sensors and a surface member. The sensors are arranged at positions corresponding to the pulp region of the finger to detect the force. The surface member covers the finger and the sensors. The sensors are arrayed in a circumferential direction with a predetermined gap. A portion of the surface member covering the pulp region is formed of an elastic material. The portion of the surface member covering the pulp region has an easily-deformable portion at least in a range corresponding to the gap.

### CROSS REFERENCE TO RELATED APPLICATION

This application is based on Japanese Patent Application No. 2024-091366 filed in Japanese Patent Office on Jun. 5, 2024, contents of which are hereby incorporated by reference.

### TECHNICAL FIELD

The present invention relates to a sensor module arranged on a finger of a robot hand, a robot hand having the sensor module arranged thereon, and a robot hand system for controlling the robot hand.

### BACKGROUND ART

As for tactile sensors to be provided on robot hands, those disclosed in Japanese Patent Application Laid Open No. 2019-181578 and others have been known as prior arts. By providing tactile sensors such as pressure sensors to fingertips of robot hands, it is possible to sense a contact with a target subject to be gripped or operated, allowing the target subject to be gripped with appropriate gripping force when gripping. Also, as data analysis of tactile sensors for slip detection of rope, “Yuki Okura, Junya Sato, Takuya Daigo, Masaru Takizawa, Takashi Suehiro, Kohei Kimura, Shunsuke Kudoh, “Analysis of Fingertip Tactile Sensors for Slip Detection of Rope”, the Society of Instrument and Control Engineers, 23rd System Integration Division Annual Conference, pp. 1607-1612, Dec. 14 to 16, 2022” (hereinafter referred to as “Non-Patent Literature 1”) has been known. FIG. 1 depicts a sensor module depicted in FIG. 1 of Non-Patent Literature 1.

### SUMMARY OF THE INVENTION

However, the tactile sensor of Non-Patent Literature 1 is limited to detect sliding of a specific string, and cannot support various strings and various sliding speeds. The present invention has an object of widening the range of types of string and sliding speeds for which sliding is detectable by a sensor module.

A sensor module of the present invention is arranged on a finger of a robot hand. The finger has a pulp region for applying a force to a subject, and a back region opposite to the pulp region. The sensor module of the present invention includes two or more sensors and a surface member. The sensors are arranged at positions corresponding to the pulp region of the finger to detect the force. The surface member covers the finger and the sensors. The sensors are arrayed in a circumferential direction with a predetermined gap. A portion of the surface member covering the pulp region is formed of an elastic material. The portion of the surface member covering the pulp region has an easily-deformable portion in a range corresponding to the gap.

According to the sensor module of the present invention, two or more sensors are arrayed in a circumferential direction of the finger with a gap. The portion of the surface member covering the pulp region is formed of an elastic material, and has an easily-deformable portion in a range corresponding to the gap. Thus, a difference occurs between outputs from the two or more sensors arrayed in the circumferential direction due to sliding. Therefore, it is possible to widen the range of types of string and sliding speeds for which sliding is detectable by the sensor module.

### BRIEF DESCRIPTION OF THE DRAWINGS

FIG. 1 depicts a sensor module depicted in FIG. 1 of Non-Patent Literature 1.

FIG. 2 is a diagram illustrating a sensor module of a first embodiment viewed from a fingertip side of a robot hand.

FIG. 3 is a diagram illustrating the sensor module of the first embodiment viewed from a pulp region side of the robot hand.

FIG. 4 is a diagram illustrating a sensor module of a first modification of the first embodiment viewed from the fingertip side of the robot hand.

FIG. 5 is a diagram illustrating the sensor module of the first modification of the first embodiment viewed from the pulp region side of the robot hand.

FIG. 6 is a diagram illustrating an example of functional configuration of a robot system.

FIG. 7 is a diagram illustrating an array of sensors of a sensor module used in an experiment.

FIG. 8 is a diagram illustrating an outer appearance of the sensor module used in the experiment.

FIG. 9 is a diagram illustrating a state of a robot used in the experiment.

FIG. 10 is a diagram illustrating outputs from sensors 110-1 to 110-3, 111-1 to 111-3, and 112-1 to 112-3 when a finger 910 has a nonagonal sectional shape and a vinylon-made 12-strand string is pulled by force control.

FIG. 11 is a diagram illustrating outputs from the sensors 110-1 to 110-3, 111-1 to 111-3, and 112-1 to 112-3 when the finger 910 has a nonagonal sectional shape and a vinylon-made 3-strand string is pulled by force control.

FIG. 12 is a diagram illustrating outputs from the sensors 110-1 to 110-3, 111-1 to 111-3, and 112-1 to 112-3 when the finger 910 has a circular sectional shape and a nylon-made 12-strand string is pulled by speed control. FIG. 13 is a diagram illustrating an example of a functional configuration of a computer.

### DETAILED DESCRIPTION OF THE EMBODIMENTS

In the following, an embodiment of the present invention is described in detail. Note that components having the same function are provided with the same reference numeral and redundant description of these components is omitted.

### First Embodiment

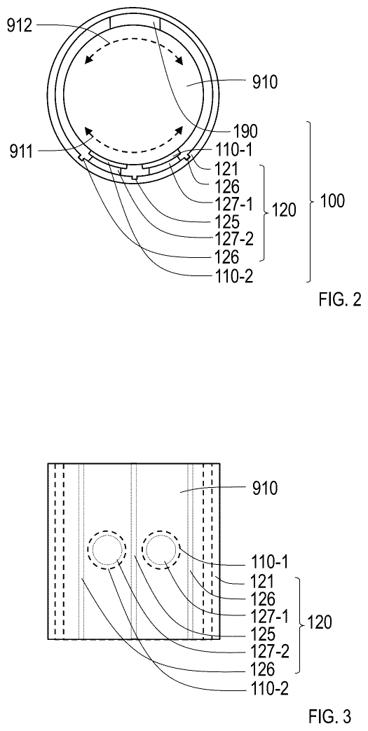

FIG. 2 illustrates a sensor module of a first embodiment viewed from a fingertip side of a robot hand. FIG. 3 illustrates the sensor module of the first embodiment viewed from a pulp region side of the robot hand. A sensor module 100 is arranged on a finger 910 of the robot hand. The finger 910 has a pulp region 911 for applying a force to a subject and a back region 912 opposite to the pulp region 911. The sensor module 100 has two or more sensors 110-1 and 110-2, a surface member 120, and a fixing portion 190. The “region for applying a force to a subject” is a region for gripping or operating the subject.

The sensors 110-1 and 110-2 are arranged at positions corresponding to the pulp region 911 of the finger 910 to detect a force. The “positions corresponding to the pulp region 911 of the finger 910” may be a surface of the finger 910 itself or positions when another matter is interposed between the finger 910 and the sensors 110-1 and 110-2. As the sensors 110-1 and 110-2, for example, pressure sensors in which a resistance value changes when a force is applied, or the like are used. The sensors are arrayed in a circumferential direction with a predetermined gap. The “circumferential direction” means a circumferential direction of a column with a direction from the base of the finger to the fingertip taken as an axis.

In the circumferential direction, two or more sensors are arrayed. Two or more sensor rows each having sensors arrayed in the circumferential direction may be provided. For example, three sensor rows each having three sensors arrayed in the circumferential direction may be formed. In this case, nine sensors are arrayed in a 3 -by-3 matrix. While the finger 910 of FIG. 2 has a circular sectional shape, the finger 910 may have a polygonal sectional shape. For example, the finger 910 may have a regular nonagonal sectional shape.

The surface member 120 covers the finger 910 and the sensors 110-1 and 110-2. The fixing portion 190 fixes the surface member 120 to the finger 910 so that the surface member 120 and the finger 910 have a gap therebetween. A portion of the surface member 120 covering the pulp region 911 is formed of an elastic material. The portion of the surface member 120 covering the pulp region 911 has an easily-deformable portion in a range corresponding to the gap between the sensors 110-1 and 110-2. With the “easily-deformable portion” formed, the surface member 120 is easily deformable, easily causing a difference between outputs from the two or more sensors arrayed in the circumferential direction due to sliding. Furthermore, an easily-deformable portion may be provided to the portion of the surface member 120 covering the pulp region 911 in a range corresponding to both ends of the sensors 110-1 and 110-2 arrayed in the circumferential direction. The “range corresponding to both ends” means a portion near portions opposed to the positions of the both ends. With an easily-deformable portion formed also in the range corresponding to both ends, a difference is further easily caused between outputs from the two or more sensors arrayed in the circumferential direction due to sliding. In the example of FIG. 2, the “easily-deformable portion” corresponds to grooves 125 and 126. However, the “easily-deformable portion” is not limited to a groove. For example, for the “easily-deformable portion”, an elastic material softer than its peripheral elastic material may be used, a cavity or foam may be provided inside for softening, or a portion having not a distinct shape like a groove but a thin thickness may be formed. The “portion having a thin thickness” also includes a portion having a distinct shape like a groove. The surface member 120 can be formed of resin 121. If a portion of the surface member 120 covering the back region 912 is made harder than the portion covering the pulp region 911, the sensor module 100 is easily fixed to the finger 910.

The sensors 110-1 and 110-2 may be directly attached to the finger 910 of the robot hand. In this case, the surface member 120 is removably attached as an outer grip so as to cover the finger 910. Alternatively, the sensors 110-1 and 110-2 may be attached to the surface member 120. In this case, the surface member 120 is removably attached as an outer grip so as to cover the finger 910 together with the sensors 110-1 and 110-2.

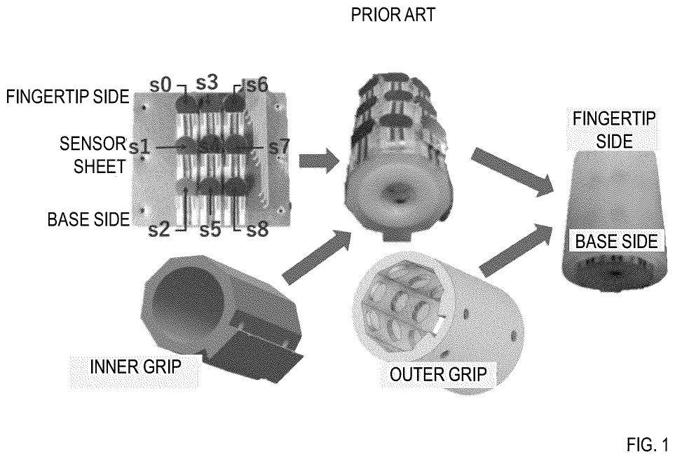

When the sensors 110-1 and 110-2 are directly attached to the finger 910 of the robot hand, convex portions 127-1 and 127-2 may be formed at positions on the inner surface of the surface member 120 corresponding to the sensors 110-1 and 110-2. The convex portion 127-1 is in contact with the sensor 110-1, and the convex portion 127-2 is in contact with the sensor 110-2. Note that Non-Patent Literature 1 is a document published by the applicant of the present application. While the outer grip (corresponding to the surface member) of Non-Patent Literature 1 depicted in FIG. 1 has convex portions on its inner surface, the convex portions are not designed to be in contact with sensors. In the sensor module 100, all convex portions are each in contact with its corresponding sensor. With this, sliding is easily detected also from an output from a sensor not at a position gripping a subject.

According to the sensor module 100, the two or more sensors 110-1 and 110-2 are arrayed in the circumferential direction of the finger 910 with a gap therebetween. The portion of the surface member 120 covering the pulp region 911 is formed of an elastic material, and has an easily-deformable portion in the range corresponding to the gap. Thus, a difference occurs between outputs from the two or more sensors 110-1 and 110-2 arrayed in the circumferential direction due to sliding. Therefore, it is possible to widen the range of types of string and sliding speeds for which sliding is detectable by the sensor module 100. Also, since the surface member 120 can be removably attached as an outer grip so as to cover the finger 910, the sensors can be easily attached and removed.

### First Modification

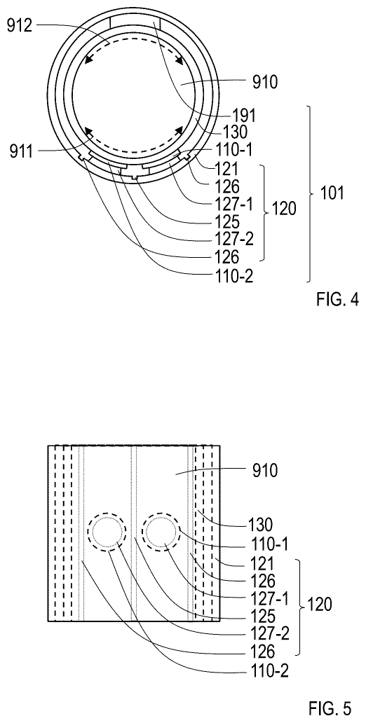

FIG. 4 illustrates a sensor module of a first modification of the first embodiment viewed from the fingertip side of the robot hand. FIG. 5 illustrates the sensor module of the first modification of the first embodiment viewed from the pulp region side of the robot hand. A sensor module 101 is arranged on the finger 910 of the robot hand. The sensor module 101 includes, in addition to the components included in the sensor module 100, a cylindrical inner grip 130. The shape of the inner grip 130 may be a cylinder or a polygonal tube. Except the inner grip 130, the sensor module 101 is identical to the sensor module 100.

The inner grip 130 is put to removably cover the finger 910 of the robot hand. When the sensors 110-1 and 110-2 are attached to the inner grip 130, the surface member 120 is removably attached as an outer grip so as to cover the inner grip 130. When the sensors 110-1 and 110-2 are attached to the surface member 120, the surface member 120 is removably attached as an outer grip so as to cover the finger 910 together with the sensors 110-1 and 110-2.

When the sensors 110-1 and 110-2 are attached to the inner grip 130, the convex portions 127-1 and 127-2 may be formed at positions on the inner surface of the surface member 120 corresponding to the sensors 110-1 and 110-2. The convex portion 127-1 is in contact with the sensor 110-1, and the convex portion 127-2 is in contact with the sensor 110-2.

According to the sensor module 101, as with the sensor module 100, the two or more sensors 110-1 and 110-2 are arrayed in the circumferential direction of the finger 910 with a gap therebetween. A portion of the surface member 120 covering the pulp region 911 is formed of an elastic material, and has an easily-deformable portion at least in a range corresponding to the gap. Thus, a difference occurs between outputs from the two or more sensors 110-1 and 110-2 arrayed in the circumferential direction due to sliding. Therefore, it is possible to widen the range of types of string and sliding speeds for which sliding is detectable by the sensor module 101. Also, since the surface member 120 can be removably attached as an outer grip so as to cover the finger 910, the sensors can be easily attached and removed.

Furthermore, an easily-deformable portion may be provided to the portion of the surface member 120 covering the pulp region 911 in a range corresponding to both ends of the sensors 110-1 and 110-2 arrayed in the circumferential direction.

### Second Embodiment

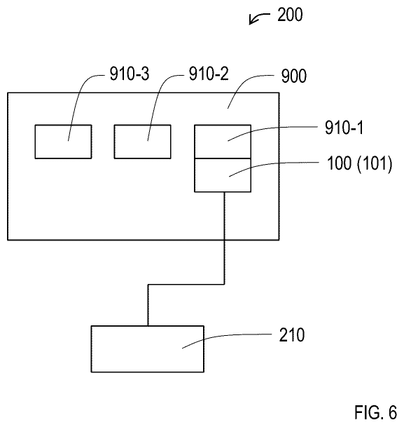

FIG. 6 illustrates an example of functional configuration of a robot system. A robot system 200 includes a robot hand 900 and a robot hand control device 210. The robot hand 900 has a plurality of fingers 910-1, 910-2, and 910-3. In FIG. 6, the sensor module 100 or the sensor module 101 is attached to the finger 910-1. The robot hand control device 210 is connected to the sensor module 100 or the sensor module 101.

The robot hand control device 210 detects a sliding state of a gripped subject based on outputs from the two or more sensors 110-1 and 110-2 arrayed in a circumferential direction of the finger 910-1 of the robot hand 900. More specifically, a sliding state of a gripped subject is detected based on a difference between the outputs from predetermined two sensors among the two or more sensors arrayed in the circumferential direction. The “difference between the outputs” includes a differential value, a difference in the way of change, and so forth. This will be described with reference to the result of an experiment below.

### Experiment

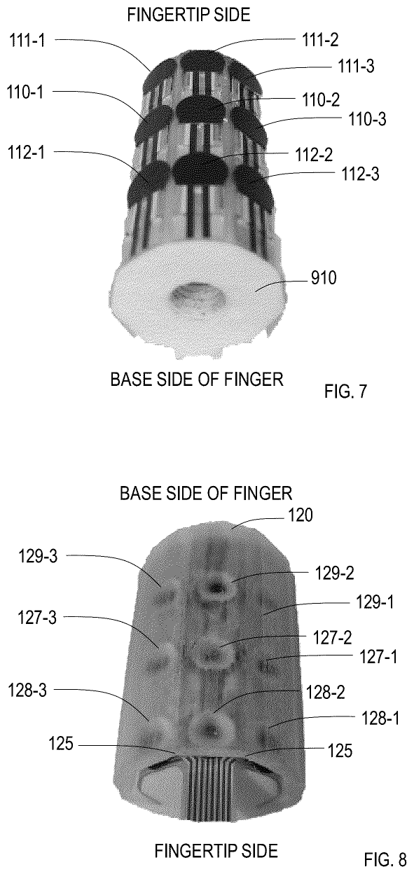

FIG. 7 illustrates an array of sensors of a sensor module used in an experiment. FIG. 8 illustrates an outer appearance of the sensor module used in the experiment. In FIG. 7, a base side of the finger is depicted at front (lower side in the drawing). In FIG. 8, a fingertip side is depicted at front (lower side in the drawing). Three sensor rows each having three sensors arrayed in the circumferential direction are formed (110-1 to 110-3, 111-1 to 111-3, 112-1 to 112-3). The sensors 110-1 to 110-3, 111-1 to 111-3, and 112-1 to 112-3 are directly attached to the finger 910. As the sensors, pressure sensor elements in which a resistance value changes with pressure were used. Outputs from a circuit that detects resistance values of these pressure sensor elements were inputted to a computer and acquired as digital values of 12 bits. That is, each output is measured as an integer value of 0 to 4095. Note that as the value is larger, the resistance value is smaller.

On the inner surface of the surface member 120, convex portions 127-1 to 127-3, 128-1 to 128-3, and 129-1 to 129-3 are formed at positions corresponding to the sensors 110-1 to 110-3, 111-1 to 111-3, and 112-1 to 112-3. The surface member 120 also has a groove 125 formed therein. A portion of the surface member 120 covering the pulp region was made of silicon rubber with Shore hardness of A30.

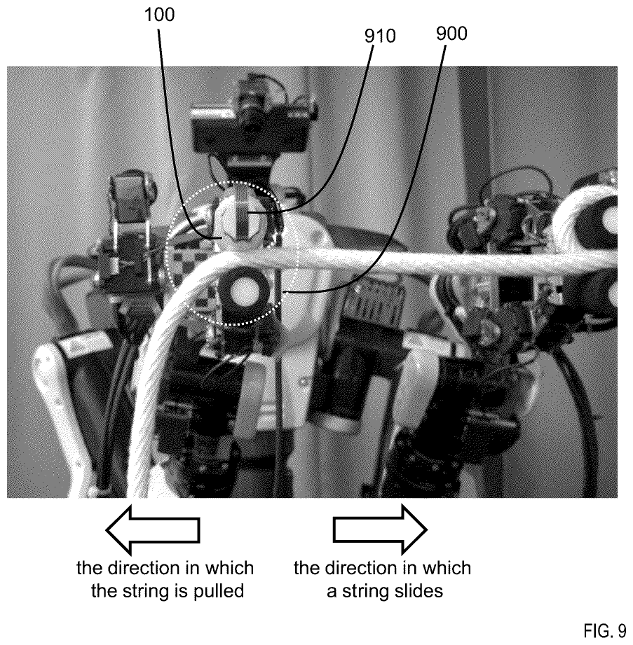

FIG. 9 illustrates a state of a robot used in the experiment. The robot hand 900 grips a string by using the finger 910 having the sensor module 100 attached thereto. In this experiment, the string is gripped at the position of the sensor 110-2 of FIG. 7. The sensors 110-1, 111-1, and 112-1 of FIG. 7 are on a left side of FIG. 9 (a side on which a tensile force is not applied to the string), and the sensors 110-3, 111-3, and 112-3 of FIG. 7 are on a right side of FIG. 9 (a side on which a tensile force is applied to the string). In the specification, a direction in which the robot hand 900 pulls the string is depicted on the left side of FIG. 9, and a direction in which the string slides is depicted on the right side of FIG. 9.

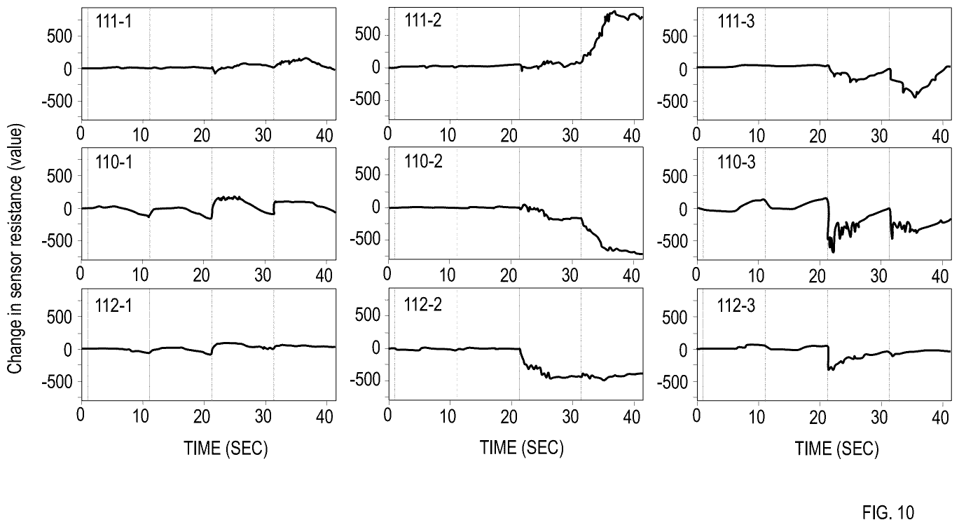

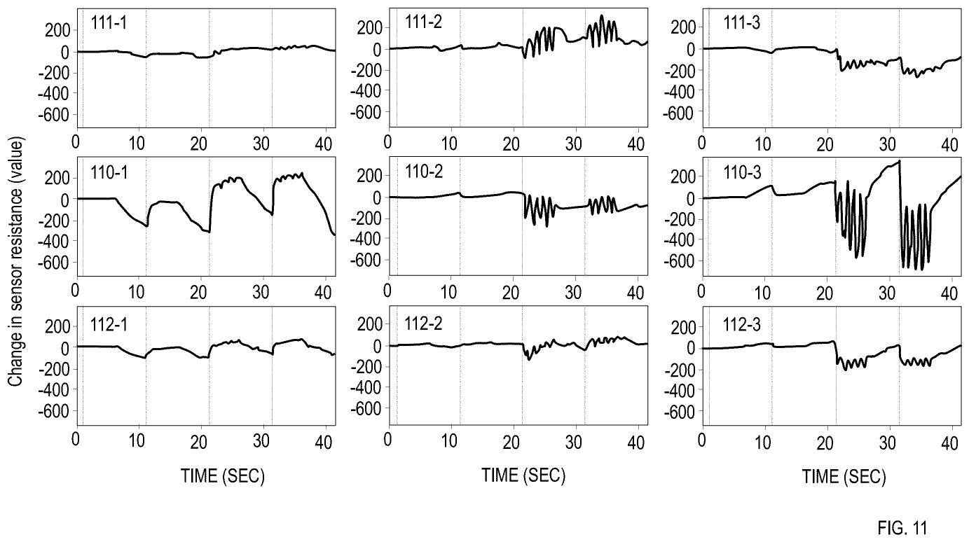

FIG. 10 illustrates outputs from the sensors 110-1 to 110-3, 111-1 to 111-3, and 112-1 to 112-3 when the finger 910 has a nonagonal sectional shape and a vinylon-made 12-strand string is pulled by force control. FIG. 11 illustrates outputs from the sensors 110-1 to 110-3, 111-1 to 111-3, and 112-1 to 112-3 when the finger 910 has a nonagonal sectional shape and a vinylon-made 3-strand string is pulled by force control. From which sensor the output comes is indicated in the drawings by the reference numeral of the sensor. For example, an upper stage on left indicates the output from the sensor 111-1, and a middle stage on left indicates the output from the sensor 110-1. In force control depicted in FIG. 10 and FIG. 11, the process is performed in which pulling is performed with 5 N for five seconds, stops for five seconds, performed with 5 N for five seconds, stops for five seconds, performed with 15 N for five seconds, stops for five seconds, performed with 15 N for five seconds, and then stops. In both FIG. 10 and FIG. 11, the horizontal axis indicates time (seconds) and the vertical axis indicates change (value) in a value corresponding to a sensor resistance value from an initial value. The initial value herein is a value corresponding to a resistance value when the finger 910 grips the string and is not pulling the string. In both drawings, the string does not slide with a force of 5 N. The string starts sliding when pulled with a force of 15 N. When the string starts sliding, the value of the sensor 110-2 at the position gripping the string unstably changes. The reason for this is thought that a sliding state and a stop state are repeated. Also, it can be found that the change in the value of the sensor 110-3 arranged on a side on which a tensile force is applied to the string is larger than the change in the value of the sensor 110-2 at the position gripping the string. On the other hand, it can be found that the change in the value of the sensor 110-1 on the side on which a tensile force is not applied to the string is small.

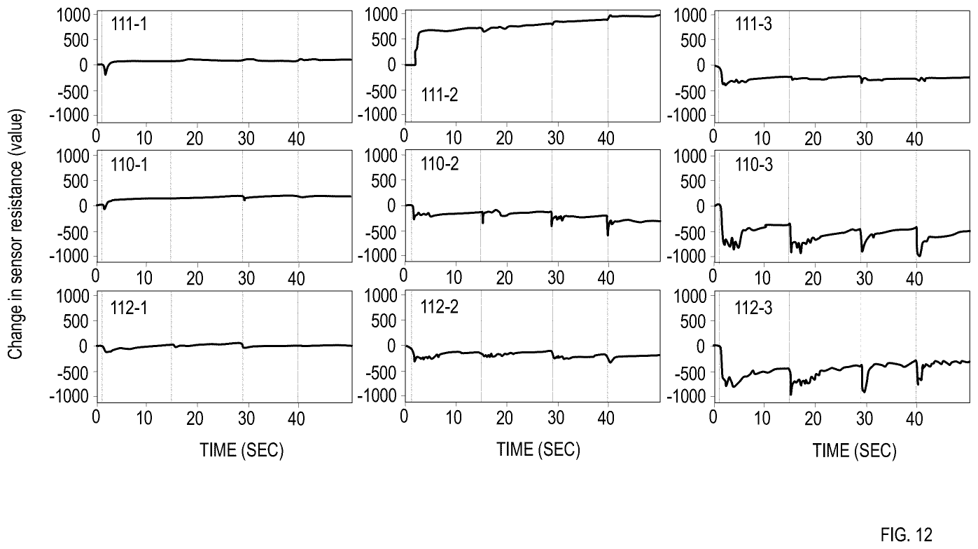

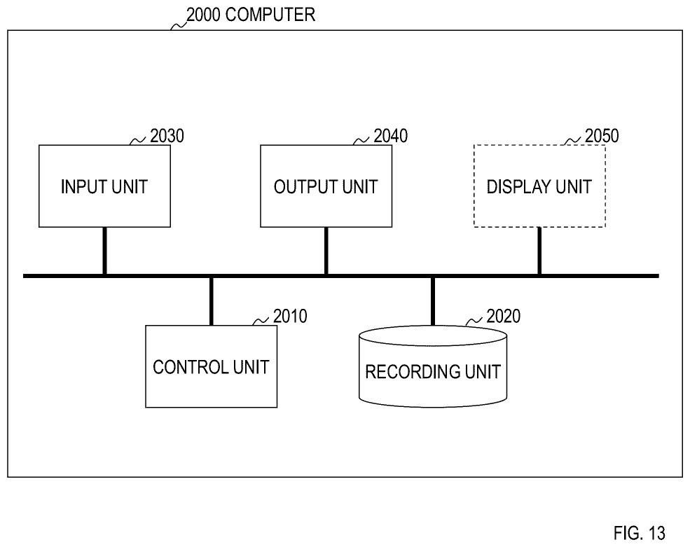

FIG. 12 illustrates outputs from the sensors 110-1 to 110-3, 111-1 to 111-3, and 112-1 to 112-3 when the finger 910 has a circular sectional shape and a nylon-made 12-strand string is pulled by speed control. In speed control, the process is performed in which pulling is performed at a maximum speed of 60 mm/sec, stops, performed at a maximum speed of 60 mm/sec, stops, performed at a maximum speed of 240 mm/sec, stops, performed at a maximum speed of 470 mm/sec, and then stops. Since speed control starts from a stop state and then stops, the process is such that acceleration is made from the stop state, control is performed in which the speed becomes constant at a maximum speed, and then deceleration is made for stop. When pulling is performed quickly, the pulling time is shortened. Also in FIG. 12, the horizontal axis indicates time (seconds) and the vertical axis indicates change (value) in a value corresponding to a sensor resistance value from an initial value. Pulling is performed at a timing of every 10 seconds. Because of speed control, sliding occurred at each of four times of pulling. Also in the example of FIG. 12, it can be found that the change in the value of the sensor 110-3 arranged on a side on which a tensile force is applied to the string is larger than the change in the value of the sensor 110-2 at the position gripping the string. On the other hand, it can be found that the change in the value of the sensor 110-1 on the side on which a tensile force is not applied to the string is small. The value of the sensor 110-2 at the position gripping the string unstably changes at first three times to the extent of being easily recognizable even by visual check. While the value unstably changes also at the fourth time, the magnitude of change is small. However, when a difference in change is checked between the sensor 110-1 and the sensor 110-3, it can be recognized that sliding has occurred. Also, although the sensor row does not include a sensor at a gripping position, from the changes in the value of the sensors 112-1 to 112-3, it can also be similarly recognized that sliding has occurred.

From these above, it can be found that the sliding state of the gripped subject can be detected based on outputs from two or more sensors arrayed in the circumferential direction of the finger 910 of the robot hand 900. More specifically, it can be found that sliding starts when the output from the sensor unstably changes. Furthermore, it can be found that the string slides to a sensor the value of which is greatly unstably changing among the sensors arranged in the circumferential direction. For example, when the sensor 110-1 and the sensor 110-3 are taken as predetermined two sensors, a direction in which the string is sliding can be found based on the outputs from these two sensors. That is, the sliding state of the gripped subject can be detected based on a difference between the outputs from the predetermined two sensors among two or more sensors arrayed in the circumferential direction. Also, from the experiment described above, according to the sensor module 100 or 101, it can be found that it is possible to widen the range of types of string and sliding speeds for which sliding is detectable. Note that since sliding can be detected from the values of the sensors 112-1 to 112-3 of FIG. 12, it can be found that sliding can be detected even when the sensor is not arranged at a position accurately gripping the subject.

### Processor, Program, and Recording Medium

The processing by the above-described robot hand control device 210 can be performed by allowing a recording unit 2020 of a computer 2000 illustrated in FIG. 13 to read a program for execution of each step of the above-described method and allowing a control unit 2010, an input unit 2030, an output unit 2040, a display unit 2050, and the like to operate.

The program describing the processing details can be recorded on a computer-readable recording medium. The computer-readable recording medium may be any kind, such as a magnetic recording device, an optical disk, a magneto-optical recording medium, or a semiconductor memory.

Also, the distribution of this program is performed by, for example, selling, transferring, or lending a portable recording medium such as a DVD or a CD-ROM on which the program is recorded. Furthermore, a configuration may be adopted in which this program is distributed by storing the program in a storage device of a server computer and transferring the program to other computers from the server computer via a network.

The computer that executes such a program first, for example, temporarily stores the program recorded on the portable recording medium or the program transferred from the server computer in a storage device thereof. At the time of execution of processing, the computer then reads the program stored in the storage device thereof and executes the processing in accordance with the read program. Also, as another form of execution of this program, the computer may read the program directly from the portable recording medium and execute the processing in accordance with the program and, furthermore, every time the program is transferred to the computer from the server computer, the computer may sequentially execute the processing in accordance with the received program. Also, a configuration may be adopted in which the transfer of a program to the computer from the server computer is not performed and the processing is executed by so-called application service provider (ASP)-type service by which the processing functions are implemented only by an instruction for execution thereof and result acquisition. Furthermore, a configuration may be adopted in which terminal processing is executed by using so-called software as a service (SaaS)-type service that causes a user to use part of a server computer together with a program. Note that a program in this form shall encompass information that is used in processing by an electronic computer and acts like a program (such as data that is not a direct command to a computer but has properties prescribing computer processing).

Further, although the present device was described as being configured via execution of a predetermined program on a computer in this form, at least some of these processing details may instead be embodied with hardware.

The foregoing description of the embodiment of the invention has been presented for the purpose of illustration and description. It is not intended to be exhaustive and to limit the invention to the precise form disclosed. Modifications or variations are possible in light of the above teaching. The embodiment was chosen and described to provide the best illustration of the principles of the invention and its practical application, and to enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

What is claimed is:

1. A sensor module arranged on a finger of a robot hand,
the finger having a pulp region for applying a force to a subject, and a back region opposite to the pulp region,
the sensor module comprising:
two or more sensors arranged at positions corresponding to the pulp region of the finger to detect the force; and
a surface member that covers the finger and the sensors, wherein
the sensors are arrayed in a circumferential direction with a predetermined gap,
a portion of the surface member covering the pulp region is formed of an elastic material, and
the portion of the surface member covering the pulp region has an easily-deformable portion at least in a range corresponding to the gap.

2. A sensor module arranged on a finger of a robot hand,
the finger having a pulp region for applying a force to a subject, and a back region opposite to the pulp region,
the sensor module comprising:
two or more sensors arranged at positions corresponding to the pulp region of the finger to detect the force; and
a surface member that covers the finger and the sensors, wherein
the sensors are arrayed in a circumferential direction with a predetermined gap,
a portion of the surface member covering the pulp region is formed of an elastic material, and
the portion of the surface member covering the pulp region has a portion locally having a thin thickness at least in a range corresponding to the gap.

3. The sensor module according to claim 1, wherein
the portion of the surface member covering the pulp region further has an easily-deformable portion in a range corresponding to both ends of the sensors arrayed in the circumferential direction.

4. The sensor module according to claim 2, wherein
the portion of the surface member covering the pulp region further has a portion locally having a thin thickness in a range corresponding to both ends of the sensors arrayed in the circumferential direction.

5. The sensor module according to claim 1, wherein
the surface member is made of resin, and
a portion of the surface member covering the back region is harder than the portion covering the pulp region.

6. The sensor module according to claim 5, wherein
the sensor is directly attached to the finger of the robot hand, and
the surface member is removably attached as an outer grip so as to cover the finger.

7. The sensor module according to claim 5, further comprising:
a cylindrical inner grip, wherein
the inner grip removably covers the finger of the robot hand, and
the surface member is removably attached as an outer grip so as to cover the inner grip.

8. The sensor module according to claim 5, wherein
the sensors are attached to the surface member, and
the surface member is removably attached as an outer grip so as to cover the finger together with the sensors.

9. The sensor module according to claim 6, wherein
convex portions are formed at positions on an inner surface of the surface member corresponding to the sensors, and
the convex portions are in contact with the sensors.

10. The sensor module according to claim 7, wherein
convex portions are formed at positions on an inner surface of the surface member corresponding to the sensors, and
the convex portions are in contact with the sensors.

11. A robot hand having attached thereto the sensor module according to claim 1.

12. A robot hand having attached thereto the sensor module according to claim 2.

13. A robot system comprising:
a robot hand having attached thereto the sensor module according to claim 1; and
a robot hand control device connected to the sensor module.

14. The robot system according to claim 13, wherein
the robot hand control device detects a sliding state of a gripped subject based on outputs from the two or more sensors arrayed in the circumferential direction of the finger of the robot hand.

15. The robot system according to claim 13, wherein
the robot hand control device detects a sliding state of a gripped subject based on a difference between outputs from predetermined two sensors among the two or more sensors arrayed in the circumferential direction of the finger of the robot hand.

16. A robot system comprising:
a robot hand having attached thereto the sensor module according to claim 2; and
a robot hand control device connected to the sensor module.

17. The robot system according to claim 16, wherein
the robot hand control device detects a sliding state of a gripped subject based on outputs from the two or more sensors arrayed in the circumferential direction of the finger of the robot hand.

18. The robot system according to claim 16, wherein
the robot hand control device detects a sliding state of a gripped subject based on a difference between outputs from predetermined two sensors among the two or more sensors arrayed in the circumferential direction of the finger of the robot hand.
